(19) United States
(12) Patent Application Publication
(10) Pub. No.: US 2026/0172535 A1
(43) Pub. Date: Jun. 18, 2026

(54) FLICKER-REDUCED IMAGE GENERATION DEVICE, MULTIFOCAL DISPLAY SYSTEM, AND OPERATING METHOD THEREOF

(71) Applicant: ELECTRONICS AND TELECOMMUNICATIONS RESEARCH INSTITUTE, Daejeon (KR)

(72) Inventors: WOOSEUP YOUM, Daejeon (KR); Jae-Hyeung PARK, Yongin-si (KR); Kukjoo KIM, Daejeon (KR); Yongduck KIM, Daejeon (KR); Jiyun HAN, Suncheon-si (KR); Woongseob HAN, Cheonan-si (KR); CHUNWON BYUN, Daejeon (KR); DAE HYUN AHN, Daejeon (KR); Hyunsu CHO, Daejeon (KR); Chul Woong JOO, Daejeon (KR)

(21) Appl. No.: 19/395,336

(22) Filed: Nov. 20, 2025

(30) Foreign Application Priority Data
Dec. 12, 2024 (KR) 10-2024-0184766
Jul. 29, 2025 (KR) 10-2025-0103069

(51) Int. Cl. H04N 13/144; H04N 13/128; H04N 13/344; H04N 13/398

(52) U.S. Cl. CPC H04N 13/144; H04N 13/128; H04N 13/344; H04N 13/398

(57) ABSTRACT

A flicker-reduced image generation device includes a focal plane extractor that extracts a plurality of focal plane images corresponding to each of a plurality of focal planes from a multifocal image frame, at least one image processor that performs defocusing processing on focal plane images of each of remaining focal planes excluding a target focal plane among the plurality of focal planes, an image synthesizer that generates a flicker-reduced image corresponding to the target focal plane based on a focal plane image of the target focal plane and the defocused focal plane images of each of the remaining focal planes, and an operation controller that determines the target focal plane among the plurality of focal planes and controls the focal plane extractor, the at least one image processor, and the image synthesizer to generate the flicker-reduced image.

### CROSS-REFERENCE TO RELATED APPLICATIONS

This application claims priority under 35 U.S.C. § 119 to Korean Patent Application Nos. 10-2024-0184766 filed on Dec. 12, 2024, and 10-2025-0103069 filed on Jul. 29, 2025, in the Korean Intellectual Property Office, the disclosures of which are incorporated by reference herein in their entireties.

### BACKGROUND

### 1. Field of the Invention

Embodiments of the present disclosure described herein relate to a display system, and more particularly, relate to a flicker-reduced image generation device, a multifocal display system, and an operating method thereof.

### 2. Description of Related Art

Multifocal stereoscopic images may provide viewers with a high sense of space and immersion. Multifocal display systems may display images corresponding to each focal length while varying the focal length to display multifocal stereoscopic images. The multifocal display systems may synchronize a display panel with a device (e.g., a variable focal lens or a curvature-changing mirror with adjustable surface curvature) capable of varying focal lengths to provide the user with the illusion that images are displayed on focal planes corresponding to multiple image depths.

The multifocal display systems use multiple display frames to display multifocal stereoscopic images corresponding to a single image frame. During these multiple display frames, as the focal length of a focus conversion device changes, an image corresponding to each focal plane is displayed. Meanwhile, to reduce interference between images displayed on each focal plane, a background color (e.g., black) may be applied to everything except an object displayed on each focal plane. When displaying multifocal stereoscopic images, flicker occurs, causing the image to appear as if it's flickering due to repeated alternation of the object and the background color. This flickering may cause visual fatigue and may reduce immersion in the images. A method for reducing the flicker is needed.

### SUMMARY

Embodiments of the present disclosure provide a flicker-reduced image generation device capable of reducing flicker phenomenon, a multifocal display system, and an operating method thereof.

According to an embodiment of the present disclosure, a flicker-reduced image generation device includes a focal plane extractor that receives a multifocal image frame and extracts a plurality of focal plane images corresponding to each of a plurality of focal planes from the multifocal image frame, at least one image processor that performs defocusing processing on focal plane images of each of remaining focal planes excluding a target focal plane among the plurality of focal planes, an image synthesizer that generates a flicker-reduced image corresponding to the target focal plane based on a focal plane image of the target focal plane and the defocused focal plane images of each of the remaining focal planes, and an operation controller that determines the target focal plane among the plurality of focal planes and controls the focal plane extractor, the at least one image processor, and the image synthesizer to generate the flicker-reduced image.

According to an embodiment of the present disclosure, a multifocal display system includes a display device including at least one display panel and at least one focus conversion device, a driving circuit that generates a display driving signal for driving the display panel and a driving synchronization signal for controlling an operation of the focus conversion device synchronized with the display panel, a controller that outputs image data displayed on the display panel and a control signal for controlling the driving circuit, and a flicker-reduced image generation device that receives a multifocal image frame, extracts a plurality of focal plane images corresponding to each of a plurality of focal planes from the multifocal image frame, determines a target focal plane among the plurality of focal planes, performs defocusing processing on focal plane images of each of remaining focal planes excluding the target focal plane among the plurality of focal planes, generates a flicker-reduced image corresponding to the target focal plane based on a focal plane image of the target focal plane and the defocused focal plane images of each of the remaining focal planes, and outputs the flicker-reduced image to the controller.

According to an embodiment of the present disclosure, a method of operating a multifocal display system includes receiving a multifocal image frame, extracting a plurality of focal plane images corresponding to each of a plurality of focal planes from the multifocal image frame, determining a target focal plane among the plurality of focal planes, performing defocusing processing on focal plane images of each of remaining focal planes excluding the target focal plane among the plurality of focal planes, and generating a flicker-reduced image corresponding to the target focal plane based on a focal plane image of the target focal plane and the defocused focal plane images of each of the remaining focal planes.

### BRIEF DESCRIPTION OF THE DRAWINGS

The above and other objects and features of the present disclosure will become apparent by describing in detail embodiments thereof with reference to the accompanying drawings.

FIG. 1 is a block diagram illustrating a multifocal display system, according to an embodiment of the present disclosure.

FIG. 2 is a diagram illustrating an operation of a multifocal display system.

FIG. 3 is a diagram illustrating objects displayed according to focal lengths.

FIG. 4 is a diagram illustrating multiple focal plane images according to focal lengths in a multifocal image frame.

FIG. 5 is a diagram illustrating multiple focal planes according to display frames in a multifocal image frame.

FIG. 6 is a block diagram illustrating a flicker-reduced image generation device, according to an embodiment of the present disclosure.

FIGS. 7A to 7C are diagrams illustrating a process for generating flicker-reduced images corresponding to one multifocal image frame, according to an embodiment of the present disclosure.

FIG. 8 is a diagram illustrating flicker-reduced images displayed on a display panel according to an embodiment of the present disclosure, according to display frames.

FIG. 9 is a flowchart illustrating a flicker-reduced image generation method, according to an embodiment of the present disclosure.

FIG. 10 is a flowchart illustrating an operating method of a multifocal display system, according to an embodiment of the present disclosure.

FIG. 11 is a diagram illustrating an example of a computing system implementing a flicker-reduced image generation device, according to an embodiment of the present disclosure.

FIG. 12 is a diagram illustrating a head-mounted display device, according to an embodiment of the present disclosure.

### DETAILED DESCRIPTION

Hereinafter, embodiments of the present disclosure will be described in detail and clearly to such an extent that an ordinary one in the art easily implements the present disclosure.

Components that are described in the detailed description with reference to the terms “unit”, “module”, “block”, “˜er or ˜or”, etc. and function blocks illustrated in drawings will be implemented with software, hardware, or a combination thereof. For example, the software may be a machine code, firmware, an embedded code, and application software. For example, the hardware may include an electrical circuit, an electronic circuit, a processor, a computer, an integrated circuit, integrated circuit cores, a pressure sensor, an inertial sensor, a microelectromechanical system (MEMS), a passive element, or a combination thereof.

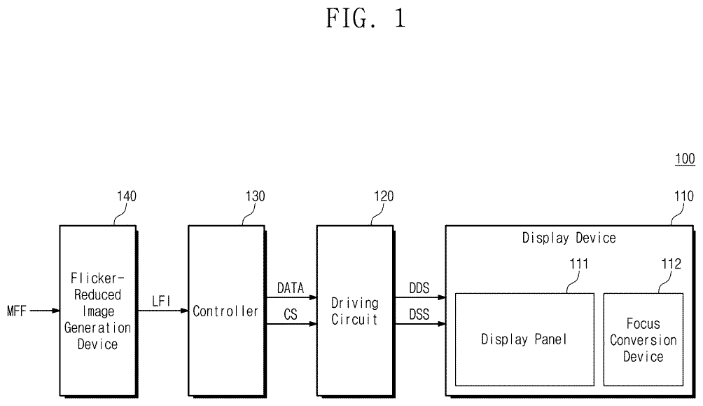

FIG. 1 is a block diagram illustrating a multifocal display system, according to an embodiment of the present disclosure.

Referring to FIG. 1, a multifocal display system 100 may include a display device 110, a driving circuit 120, a controller 130, and a flicker-reduced image generation device 140.

The multifocal display system 100 may visually provide a user with multifocal stereoscopic images. The multifocal display system 100 may display images corresponding to each focal plane while varying the focal length of the image to express a plurality of image depths (or focal planes). For example, the multifocal display system 100 may display a first focal plane image corresponding to a first focal length, a second focal plane image corresponding to a second focal length, and a third focal plane image corresponding to a third focal length.

The display device 110 may include at least one display panel 111 and at least one focus conversion device 112. The display panel 111 may include a plurality of pixels arranged in a matrix form. Each of the plurality of pixels may include a plurality of sub-pixels. Each of the plurality of pixels may express a color based on pixel data. The pixel data may be included in a display driving signal DDS and may be provided to the display panel 111.

The focus conversion device 112 may be positioned between the user's eyes and the display panel 111. The focus conversion device 112 may adjust the focal length (or diopter) to correspond to each focal plane. For example, the focus conversion device 112 may adjust the focal length to a first focal length corresponding to a first focal plane, a second focal length corresponding to a second focal plane, or a third focal length corresponding to a third focal plane. The focus conversion device 112 may adjust the focal length in synchronization with the display panel 111 such that the user may identify different focal planes.

The display device 110 may include a pair of display panels 111 and a pair of focus conversion devices 112 such that different images may be displayed to each eye. For example, the display device 110 may include the display panel 111 and the focus conversion device 112 for the left eye, and the display panel 111 and the focus conversion device 112 for the right eye. The pair of focus conversion devices 112 may adjust the focal length corresponding to the same focal plane. The display panel 111 for the left eye and the display panel 111 for the right eye may display different images on the same focal plane. The user may experience a three-dimensional effect depending on the parallax between the images displayed on the display panels 111 for each eye.

The driving circuit 120 may receive image data DATA and a control signal CS from the controller 130. The driving circuit 120 may generate the display driving signal DDS and a driving synchronization signal DSS for driving the display device 110 based on the image data DATA and the control signal CS. The display driving signal DDS may be transferred to the display panel 111. The driving circuit 120 may display an image on the display panel 111 through the display driving signal DDS. The driving circuit 120 may control an operation of the focus conversion device through the driving synchronization signal DSS. The display panel 111 may display an image according to the image data DATA based on the display driving signal DDS. The driving synchronization signal DSS may be transferred to the focus conversion device 112. The focus conversion device 112 may adjust the focal length based on the driving synchronization signal DSS. The driving circuit 120 may include a source driving circuit that provides pixel data to a plurality of columns and a gate driving circuit that sequentially activates a plurality of lines.

The controller 130 may control an operation of the driving circuit 120. The controller 130 may generate the image data DATA regarding an image to be displayed through the display device 110 and the control signal CS for controlling the operation of the driving circuit 120. The image data DATA output by the controller 130 may include focal plane images corresponding to each of a plurality of focal lengths. For example, the image data DATA may include a first focal plane image with respect to a first focal length, a second focal plane image with respect to a second focal length, or a third focal plane image with respect to a third focal length. The control signal CS is a signal for controlling the operation of the driving circuit 120. The driving circuit 120 may control the driving timing of the display device 110, etc., based on the control signal CS.

The flicker-reduced image generation device 140 may receive a multifocal image frame MFF, may extract focal plane images from the multifocal image frame MFF, and may generate a flicker-reduced image LFI corresponding to each focal plane by synthesizing the focal plane images.

The multifocal image frame MFF may include image texture and depth map data. The image texture is data containing visual information of an image. The image texture may include visual attribute values (e.g., RGB values, YUV values, etc.) corresponding to each pixel. The depth map data is data containing spatial depth (or distance) information corresponding to each pixel. The depth map data indicates how far each pixel in the image is from a reference point (e.g., a camera reference point). The depth map data may be combined with a two-dimensional image (e.g., an image texture) to provide three-dimensional information. The depth map data may be expressed as grayscale values, and the brightness value for each pixel may be expressed proportionally to the distance or depth of the corresponding pixel. The depth map data may be used as a reference for representing a three-dimensional effect or as a reference for extracting a focal plane.

The flicker-reduced image generation device 140 may extract a plurality of focal plane images corresponding to each of a plurality of focal planes based on the image texture and the depth map data included in the received multifocal image frame MFF. The flicker-reduced image generation device 140 may determine a target focal plane for generating the flicker-reduced image LFI from among the plurality of focal planes. The flicker-reduced image generation device 140 may perform defocusing processing on the focal plane images of each of the remaining focal planes, excluding the target focal plane. The flicker-reduced image generation device 140 may generate the flicker-reduced image LFI corresponding to the target focal plane based on a focal plane image of the target focal plane and defocused focal plane images of each of the remaining focal planes. The flicker-reduced image generation device 140 may synthesize the focal plane image of the target focal plane and the defocused focal plane images of each of the remaining focal planes to generate the flicker-reduced image LFI. The flicker-reduced image generation device 140 may output the flicker-reduced image LFI to the controller 130. The flicker-reduced image generation device 140 may sequentially determine the target focal plane according to a preset order. The flicker-reduced image generation device 140 may generate the flicker-reduced image LFI with respect to the newly determined target focal plane through extraction of the plurality of focal plane images, image processing, image synthesis, etc. The flicker-reduced image generation device 140 may sequentially generate the flicker-reduced image LFI with respect to all focal planes.

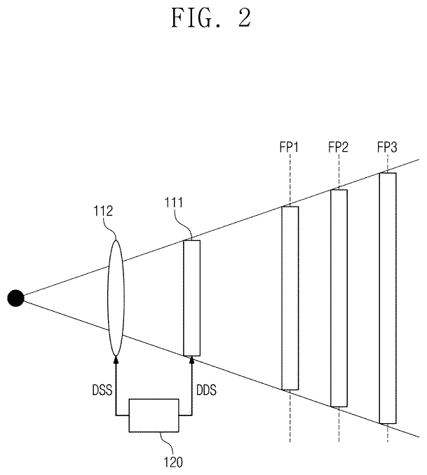

FIG. 2 is a diagram illustrating an operation of a multifocal display system.

Referring to FIG. 2, the multifocal display system 100 may display a multifocal image having the plurality of focal planes FP1, FP2, and FP3.

The display panel 111 may receive the display driving signal DDS. The display panel 111 may display an image for each frame according to the display driving signal DDS.

The focus conversion device 112 may receive the driving synchronization signal DSS from the driving circuit 120. The focus conversion device 112 may include a variable focus optical system. The focus conversion device 112 may adjust the focus of the optical system to display the plurality of focal planes FP1, FP2, and FP3 having different focal lengths.

A single image frame may include the plurality of display frames. During a first display frame included in one image frame, a first focal plane image is displayed on the display panel 111, and the focal length of the focus conversion device 112 may be adjusted to a first focal length corresponding to the first focal plane FP1. In this case, the user may perceive that the first focal plane image is displayed on the first focal plane FP1. During a second display frame included in the one image frame, a second focal plane image is displayed on the display panel 111, and the focal length of the focus conversion device 112 may be adjusted to a second focal length corresponding to the second focal plane FP2. In this case, the user may perceive that the second focal plane image is displayed on the second focal plane FP2. As in the above description, a third focal plane image may be displayed corresponding to the third focal plane FP3. Through this, a multifocal image may be provided to the user by displaying the plurality of focal planes FP1, FP2, and FP3 during each display frame in a time-division manner.

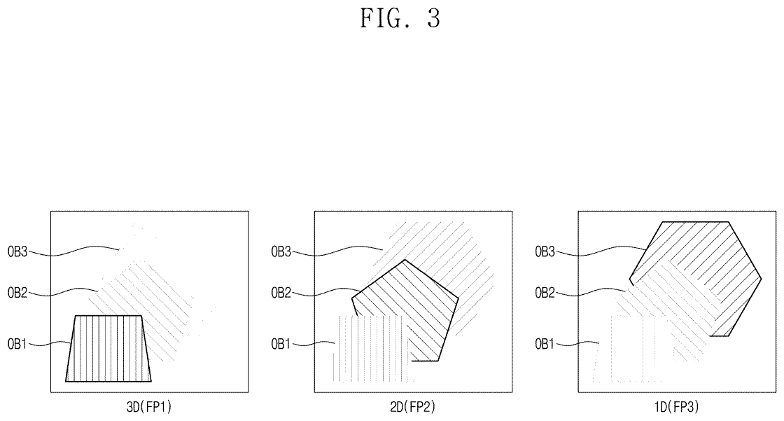

FIG. 3 is a diagram illustrating objects displayed according to focal lengths.

Referring to FIGS. 2 and 3, objects may be displayed clearly or blurred depending on the focal length.

In a multifocal image, a plurality of objects OB1, OB2, and OB3 may correspond to a near view, a middle view, and a far view, respectively. The first object OB1 is displayed as if positioned on the first focal plane FP1, the second object OB2 is displayed as if positioned on the second focal plane FP2, and the third object OB3 is displayed as if positioned on the third focal plane FP3.

To display the first object OB1 corresponding to the near view, the focal length of the focus conversion device 112 is adjusted in 3D (here, “D” is diopter), and a focal plane image including the first object OB1 may be displayed on the display panel 111. To display the second object OB2 corresponding to the middle view, the focal length of the focus conversion device 112 is adjusted to 2D, and a focal plane image including the second object OB2 may be displayed on the display panel 111. To display the third object OB3 corresponding to the far view, the focal length of the focus conversion device 112 is adjusted to 1D, and a focal plane image including the third object OB3 may be displayed on the display panel 111.

The focus conversion device 112 and the display panel 111 may implement the depths of the plurality of objects OB1, OB2, and OB3 in a time-division manner. When the user focuses on 3D, the first object OB1 is clearly perceived, while the second object OB2 and the third object OB3 are relatively blurred due to a defocus (or out of focus) effect. In this case, the third object OB3 appears relatively blurrier than the second object OB2, making it appear to be placed relatively farther away. When the user focuses on 2D, the second object OB2 is perceived clearly, while the first object OB1 and the third object OB3 are perceived relatively blurry due to the defocus effect. When the user focuses on 1D, the third object OB3 is perceived clearly, while the first object OB1 and the second object OB2 are perceived relatively blurry. In this case, the first object OB1 appears relatively blurrier than the second object OB2, making it appear to be placed relatively closer.

Hereinafter, for convenience of description, the present disclosure assumes that the focal length of the near view is 3D, the focal length of the middle view is 2D, and the focal length of the far view is 1D. The focal lengths of the near view, the middle view, and the far view may be relatively shorter or longer than the aforementioned focal lengths. Meanwhile, for convenience of description, the multifocal images are described as representing three focal lengths, but they may represent fewer or more focal lengths.

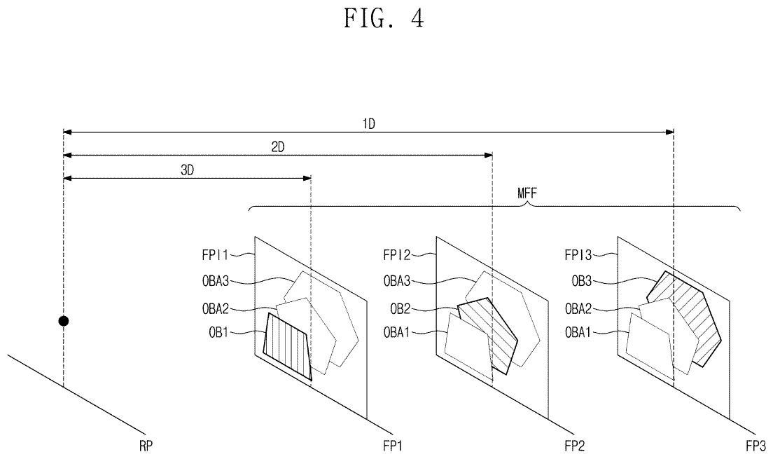

FIG. 4 is a diagram illustrating multiple focal plane images according to focal lengths in a multifocal image frame.

Referring to FIGS. 2 and 4, a plurality of focal plane images FPI1, FPI2, and FPI3 may be extracted from the multifocal image frame MFF.

The plurality of focal plane images FPI1, FPI2, and FPI3 may be displayed on the display panel 111 synchronized with the focus conversion device 112. The first focal plane image FPI1 includes the first object OB1 and may correspond to the first focal plane FP1. In this case, the focal length of the focus conversion device 112 corresponding to the first focal plane FP1 is 3D. The second focal plane image FPI2 includes the second object OB2 and may correspond to the second focal plane FP2. The focal length of the focus conversion device 112 corresponding to the second focal plane FP2 is 2D. The third focal plane image FPI3 includes the third object OB3 and may correspond to the third focal plane FP3. The focal length of the focus conversion device 112 corresponding to the third focal plane FP3 is 1D.

A second object area OBA2 and a third object area OBA3 of the first focal plane image FPI1 are display areas corresponding to the second object OB2 and the third object OB3, respectively. When the second object OB2 is displayed in the second object area OBA2 of the first focal plane image FPI1, it is difficult for the user to perceive the depth between the first and second objects. To avoid interference between the plurality of focal plane images FPI1 to FPI3, the second object area OBA2 and the third object area OBA3 of the first focal plane image FPI1 may be displayed with a background color (e.g., black).

A first object area OBA1 and the third object area OBA3 of the second focal plane image FPI2 are display areas corresponding to the first object OB1 and the third object OB3, respectively. The first object area OBA1 and the third object area OBA3 of the second focal plane image FPI2 may be displayed with a background color. The first object area OBA1 and the second object area OBA2 of the third focal plane image FPI3 may be displayed with a background color.

The background color of the plurality of focal plane images FPI1 to FPI3 may be a single color, such as black or white, but is not limited thereto. The background color may be set to a variety of colors that may provide a sense of immersion to the user.

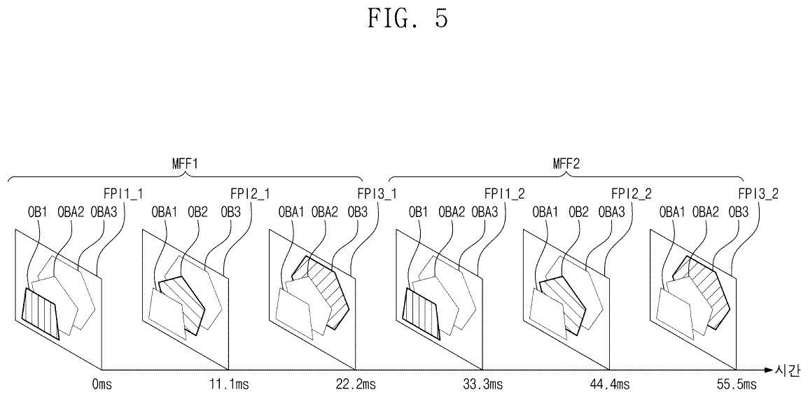

FIG. 5 is a diagram illustrating multiple focal planes according to display frames in a multifocal image frame.

Referring to FIGS. 2, 4, and 5, a plurality of focal plane images FPI1_1, FPI2_1, . . . , and FPI3_2 corresponding to each of the plurality of focal planes FP1 to FP3 may be sequentially displayed in a preset order.

It is assumed that a frame rate per second (FPS) of the display frame is 90 Hz. Three focal plane images FPI1_1 to FPI3_1 may be extracted from one multifocal image frame MFF_1. The first multifocal image frame MFF_1 may be displayed from 0 ms to 33.3 ms before.

At 0 ms point in time, the focal length of the focus conversion device 112 is adjusted in 3D, and the first focal plane image FPI1_1 including the first object OB1 may be displayed on the display panel 111. The second object area OBA2 and the third object area OBA3 of the first focal plane image FPI1_1 may be displayed with a background color. At 11.1 ms point in time, the focal length of the focus conversion device 112 is adjusted to 2D, and the second focal plane image FPI2_1 including the second object OB2 may be displayed on the display panel 111. The first object area OBA1 and the third object area OBA3 of the second focal plane image FPI2_1 may be displayed with a background color. At 22.2 ms point in time, the focal length of the focus conversion device 112 is adjusted to 1D, and the third focal plane image FPI3_1 including the third object may be displayed on the display panel 111. The first object area OBA1 and the second object area OBA2 of the third focal plane image FPI3_1 may be displayed with a background color.

The first object OB1 is displayed from 0 ms to 11.1 ms, and the background color is displayed for the remaining 11.1 ms to 33.3 ms. As in the above description, the second object OB2 is displayed only from 11.1 ms to 22.2 ms, and the background color is displayed from 0 ms to 11.1 ms and from 22.2 ms to 33.3 ms. The third object OB3 is displayed only from 22.2 ms to 33.3 ms, and the background color is displayed for the remaining 0 ms to 22.2 ms. In other words, the display time of each object may vary depending on the number of focal planes that form one image frame. When one image frame consists of three focal planes, the object is displayed in one-third of the frame, while the background color is displayed for the remainder. In this case, the object and background colors alternate, causing the user to perceive the image as flickering. This may lead to flickering. As the number of focal planes that make up the image frame increases, flickering may become more severe.

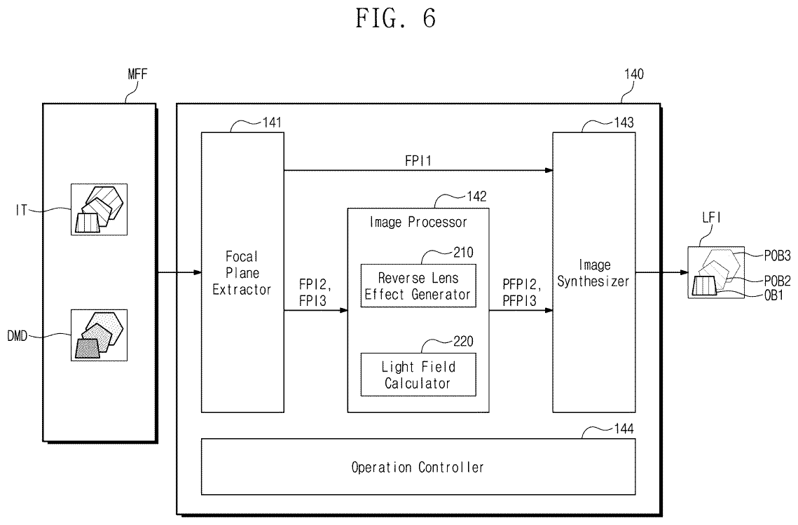

FIG. 6 is a block diagram illustrating a flicker-reduced image generation device, according to an embodiment of the present disclosure.

Referring to FIG. 6, the flicker-reduced image generation device 140 may include a focal plane extractor 141, at least one image processor 142, an image synthesizer 143, and an operation controller 144.

The flicker-reduced image generation device 140 may generate the flicker-reduced image LFI with respect to the target focal plane among the plurality of focal planes. For example, when the target focal plane is determined to be the first focal plane among the plurality of focal planes, the flicker-reduced image generation device 140 may generate the flicker-reduced image LFI corresponding to the first focal plane image FPI1.

The focal plane extractor 141 may receive the multifocal image frame MFF including an image texture IT and depth map data DMD. The focal plane extractor 141 may extract the plurality of focal plane images FPI1, FPI2, and FPI3 corresponding to each of the plurality of focal planes based on the image texture IT and the depth map data DMD. Each of the plurality of focal plane images FPI1 to FPI3 may include corresponding objects. The focal plane extractor 141 may extract the first focal plane image FPI1 including the first object OB1 from the multifocal image frame MFF, the second focal plane image FPI2 including the second object OB2, and the third focal plane image FPI3 including the third object OB3. The focal plane extractor 141 may separate the objects OB1 to OB3 from the background and extract the focal plane images FPI1 to FPI3 based on the outlines, textures, colors, etc. of the objects OB1 to OB3 with respect to each of the plurality of focal plane images FPI1 to FPI3. The extracted focal plane images FPI1 to FPI3 may be used to generate the flicker-reduced images LFI.

The focal plane extractor 141 may extract the focal plane images corresponding to each focal plane based on the depth map data DMD including depth information for each pixel. For example, the focal plane extractor 141 may extract the first focal plane image FPI1 using pixels corresponding to the first focal plane on the depth map data DMD. The focal plane extractor 141 may extract the second focal plane image FPI2 using pixels corresponding to the second focal plane on the depth map data DMD. The focal plane extractor 141 may extract the third focal plane image FPI3 using pixels corresponding to the third focal plane on the depth map data DMD.

When the focal plane image is extracted, the focal plane extractor 141 may use a linear decomposition method that determines the brightness of a specific pixel in proportion to the distance between focal planes. When the focal plane image is extracted, the focal plane extractor 141 may also use a method that extracts a specific focal plane image using a pre-trained deep learning model.

The at least one image processor 142 may be input with the focal plane images FPI2 and FPI3 with respect to remaining focal planes, excluding the target focal plane. The image processor 142 may perform defocusing processing on the input focal plane images FPI2 and FPI3. The image processor 142 may generate defocused focal plane images PFPI2 and PFPI3 as a result of the defocusing process. The defocusing process may include image processing (e.g. blur filtering) that provides a visual effect of making the focal plane images appear to be located in a different focal plane than the focal plane on which they are to be displayed. For example, the defocusing process may apply a blur effect, such as reducing the resolution of the focal plane images or reducing the sharpness of edges.

The image processor 142 may include a reverse lens effect generator 210. When the defocusing on an input focal plane image is performed, the reverse lens effect generator 210 may generate a reverse lens effect based on a difference in focal length (or diopter) between the focal planes of the input focal plane images FPI2 and FPI3 and the target focal plane. The reverse lens effect generator 210 may generate the reverse lens effect based on a geometrical method. For example, the reverse lens effect generator 210 may generate the reverse lens effect based on a geometrical optical equation that mathematically models the relationship between the focal length of the lens and the object distance. The reverse lens effect generator 210 may reduce the discomfort felt by the user by applying the reverse lens effect with respect to the focal plane images FPI2 and FPI3 to be displayed at the target focal plane.

The image processor 142 may include a light field calculator 220. The light field calculator 220 may perform a light field calculation based on light rays directed from each of the remaining focal planes toward the target focal plane. The light field calculator 220 calculates the influence on the target focal plane according to intensity of the light rays emitted by each pixel of the input focal plane images FPI2 and FPI3. The light field calculator 220 may repeatedly calculate the influence on the target focal plane by considering the intensity and the direction of the light rays for each pixel of the input focal plane images FPI2 and FPI3. Through this, the light field calculator 220 may generate the optical effect that reflects the influence of the light rays of the input focal plane images FPI2 and FPI3 on the target focal plane. The generated optical effect may be reflected in the flicker-reduced image LFI.

The image processor 142 may include a deep learning-based image processing model for performing defocusing processing on the input focal plane images FPI2 and FPI3. The deep learning-based image processing model may be a pre-trained neural network. The focal plane images FPI2 and FPI3 and a diopter difference are input into the deep learning-based image processing model. The diopter difference corresponds to the difference between the diopter value of the input focal plane images FPI2 and FPI3 and the diopter value of the target focal plane. The deep learning-based image processing model may generate the defocused focal plane images PFPI2 and PFPI3 processed using the pre-trained neural network.

The image synthesizer 143 may synthesize the input first focal plane image FPI1 and the defocused focal plane images PFPI2 and PFPI3. The flicker-reduced image LFI may be generated as a result of the synthesis. The image synthesizer 143 may generate the flicker-reduced image LFI including the first object OB1 included in the first focal plane image FPI1 with respect to the target focal plane and objects POB2 and POB3 included in each of the focal plane images PFPI2 and PFPI3 defocused by the image processor 142. The flicker-reduced image LFI may include objects with different resolutions. The object corresponding to the target focal plane may have the highest clarity, and the object furthest from the target focal plane may have the lowest clarity. The image synthesizer 143 may reflect the optical effect generated by the light field calculator 220 in the flicker-reduced image LFI.

The operation controller 144 may determine the target focal plane from among the plurality of focal planes. The operation controller 144 may control the operations of the focal plane extractor 141, the at least one image processor 142, and the image synthesizer 143 included in the flicker-reduced image generation device 140 to generate the flicker-reduced image LFI with respect to the target focal plane.

The operation controller 144 may determine the target focal plane according to a preset sequence. For example, the operation controller 144 may determine the target focal plane based on the focal length. The operation controller 144 may sequentially determine the target focal planes based on focal length, starting with the focal plane with the shortest focal length. The operation controller 144 may determine the first focal plane with the shortest focal length as the target focal plane. After the flicker-reduced image LFI with respect to the first focal plane is generated, the operation controller 144 may determine the second focal plane with a relatively longer focal length than the first focal plane as the target focal plane. After the flicker-reduced image LFI with respect to the second focal plane is generated, the operation controller 144 may determine the third focal plane with a relatively longer focal length than the second focal plane as the target focal plane. The operation controller 144 may sequentially determine each of the focal planes as the target focal plane. Through this, the operation controller 144 may generate the flicker-reduced image LFI with respect to each of the plurality of focal planes.

When the first focal plane is determined as the target focal plane, the operation controller 144 may input the second focal plane image FPI2 and the third focal plane image FPI3 corresponding to the remaining focal planes to the image processor 142. The operation controller 144 may provide information including the focal lengths of each of the focal planes to the at least one image processor 142. When the defocusing processing on the second focal plane image FPI2 is performed, the image processor 142 may use the focal lengths corresponding to the first focal plane image FPI1 and the second focal plane image FPI2. When the defocusing processing on the third focal plane image FPI3 is performed, the at least one image processor 142 may use the focal lengths corresponding to the first focal plane image FPI1 and the third focal plane image FPI3.

The operation controller 144 may provide the first focal plane image FPI1 extracted through the focal plane extractor 141 and the defocused second focal plane image PFPI2 and the defocused third focal plane image PFPI3 generated from the at least one image processor 142 to the image synthesizer 143. The image synthesizer 143 may generate the one flicker-reduced image LFI by synthesizing the first focal plane image FPI1 including the first object OB1, the defocused second focal plane image PFPI2 including the defocused second object POB2, and the defocused third focal plane image PFPI3 including the defocused third object POB3.

While the second object area OBA2 is displayed in a background color in the first focal plane image FPI1_1 of FIG. 5, the flicker-reduced image LFI may display the defocused second object POB2 instead of the background color.

When the multifocal image frame according to an embodiment of FIG. 5 is displayed, the background color and the object may be alternately displayed, resulting in a flickering phenomenon. According to an embodiment of the present disclosure, the flicker-reduced image generation device 140 displays the defocused object instead of the background color in an area where the object is displayed. Therefore, since the processed object is displayed instead of the background color in other object areas, flickering may be reduced. Due to the reduced flickering, the user may experience a relatively high level of immersion.

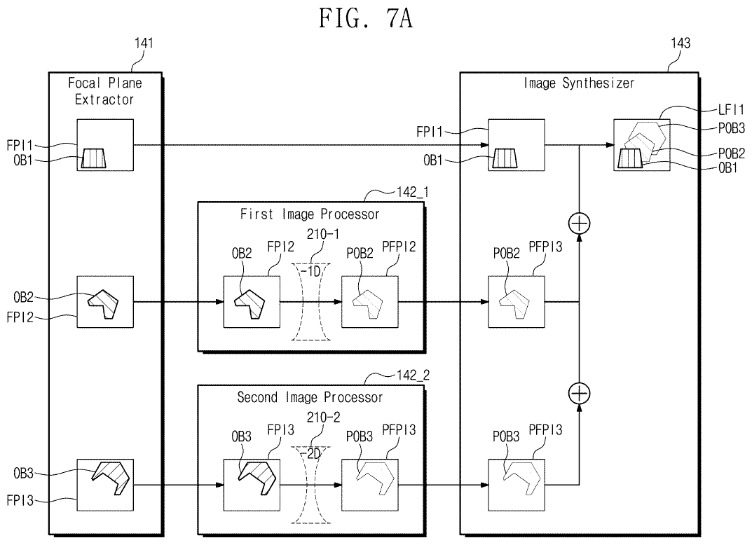

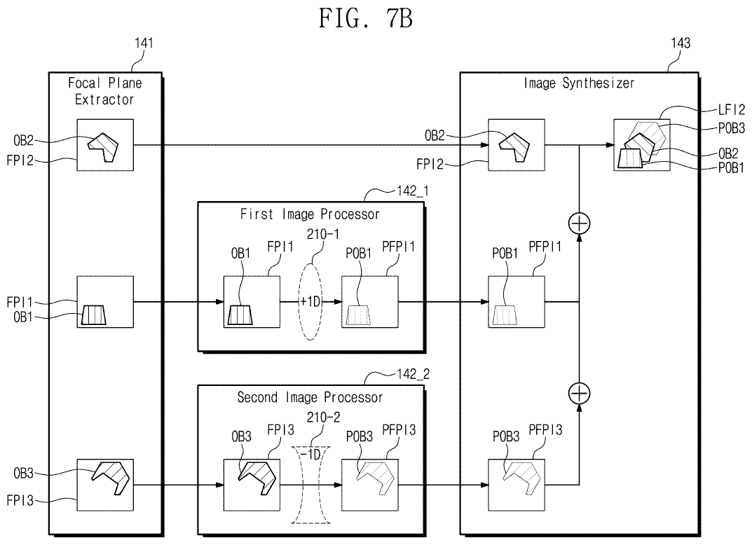

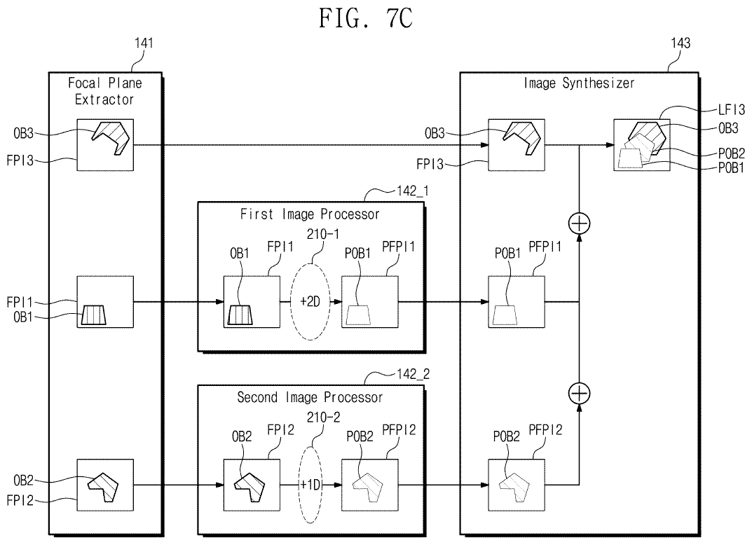

FIGS. 7A to 7C are diagrams illustrating a process for generating flicker-reduced images corresponding to one multifocal image frame, according to an embodiment of the present disclosure.

Referring to FIGS. 7A to 7C, the at least one image processor 142 may include a first image processor 142_1 and a second image processor 142_2.

The focal plane extractor 141 may extract the first focal plane image FPI1, the second focal plane image FPI2, and the third focal plane image FPI3 based on the multifocal image frame MFF. It is assumed that the focal length of the first focal plane image FPI1 is 3D, the focal length of the second focal plane image FPI2 is 2D, and the focal length of the third focal plane image FPI3 is 1D. It is assumed that the target focal plane is determined from the near view to the far view. In detail, the target focal plane is determined in the order of the first focal plane, the second focal plane, and the third focal plane.

The first focal plane image FPI1 corresponds to the near view. The first focal plane image FPI1 corresponds to the first focal plane with a 3D focal length. The first focal plane image FPI1 may include the first object OB1.

The second focal plane image FPI2 corresponds to the middle view. The second focal plane image FPI2 corresponds to the second focal plane with a 2D focal length. The second focal plane image FPI2 may include the second object OB2.

The third focal plane image FPI3 corresponds to the far view. The third focal plane image FPI3 corresponds to the third focal plane with a 1D focal length. The third focal plane image FPI3 may include the third object OB3.

FIG. 7A illustrates a case where the target focal plane is the first focal plane. The second focal plane image FPI2, which is one of the focal plane images FPI2 and FPI3 of the remaining focal planes excluding the target focal plane, is input to the first image processor 142_1. The first image processor 142_1 may perform defocusing processing on the second focal plane image FPI2. As a result of the defocusing processing, the defocused second focal plane image PFPI2 including the defocused second object POB2 may be generated.

When the defocusing processing is performed, a reverse lens effect generator 210-1 may generate a reverse lens effect for the second object OB2 based on the difference in focal length (or diopter) between the focal plane of the input object and the target focal plane. The reverse lens effect generator 210-1 may generate the reverse lens effect with respect to the second object OB2 for the shape of the second object OB2 to be displayed on the first focal plane based on the difference between the diopter (2D) of the second focal plane and the diopter (3D) of the target focal plane, which is −1D. The defocused second focal plane image PFPI2 including the defocused second object POB2 may be generated according to the operation of the reverse lens effect generator 210-1.

The third focal plane image FPI3, which is one of the focal plane images FPI2 and FPI3 of the remaining focal planes excluding the target focal plane, is input to the second image processor 142_2. The second image processor 142_2 may perform defocusing processing on the third focal plane image FPI3. As a result of the defocusing processing, the defocused third focal plane image PFPI3 including the defocused third object POB3 may be generated. The first image processor 142_1 and the second image processor 142_2 may operate in parallel.

When the defocusing processing is performed, a reverse lens effect generator 210-2 may generate a reverse lens effect for the third object OB3 based on the difference in focal length (or diopter) between the focal plane of the input object and the target focal plane. The reverse lens effect generator 210-2 may generate the reverse lens effect with respect to the third object OB3 for the shape of the third object OB3 to be displayed on the first focal plane based on the difference between the diopter (1D) of the third focal plane and the diopter (3D) of the target focal plane, which is −2D. The defocused third focal plane image PFPI3 including the defocused third object POB3 may be generated according to the operation of the reverse lens effect generator 210-2.

The image synthesizer 143 may receive the first focal plane image FPI1, the defocused second focal plane image PFPI2, and the defocused third focal plane image PFPI3. The image synthesizer 143 may generate a flicker-reduced image LFI1 corresponding to the first focal plane based on the received first focal plane image FPI1, the defocused second focal plane image PFPI2, and the defocused third focal plane image PFPI3. The image synthesizer 143 may generate one flicker-reduced image LFI1 by synthesizing, for example, the first focal plane image FPI1 corresponding to the original, and the defocused second focal plane image PFPI2 and the defocused third focal plane image PFPI3, to which the reverse lens effects are applied. The generated flicker-reduced image LFI1 may include the first object OB1, the defocused second object POB2, and the defocused third object POB3.

FIG. 7B illustrates a case where the target focal plane is the second focal plane. The first focal plane image FPI1, which is one of the focal plane images FPI1 and FPI3 of the remaining focal planes excluding the target focal plane, is input to the first image processor 142_1. The first image processor 142_1 may perform defocusing processing on the first focal plane image FPI1. As a result of the defocusing processing, a defocused first focal plane image PFPI1 including a defocused first object POB1 may be generated.

The reverse lens effect generator 210-1 may generate the reverse lens effect with respect to the first object OB1 for the shape of the first object OB1 to be displayed on the second focal plane based on the difference between the diopter (3D) of the first focal plane and the diopter (2D) of the target focal plane, which is 1D. The defocused first focal plane image PFPI1 including the defocused first object POB1 may be generated according to the operation of the reverse lens effect generator 210-1.

The third focal plane image FPI3, which is one of the objects in the remaining focal planes excluding the target focal plane, is input to the second image processor 142_2. The second image processor 142_2 may perform defocusing processing on the third focal plane image FPI3. As a result of the defocusing processing, the defocused third focal plane image PFPI3 including the defocused third object POB3 may be generated.

The reverse lens effect generator 210-2 may generate the reverse lens effect with respect to the third object OB3 for the shape of the third object OB3 to be displayed on the second focal plane based on the difference between the diopter (1D) of the third focal plane and the diopter (2D) of the target focal plane, which is −1D. According to the operation of the reverse lens effect generator 210-2, the defocused third focal plane image PFPI3 including the defocused third object POB3 may be generated.

The image synthesizer 143 may receive the second focal plane image FPI2, the defocused first focal plane image PFPI1, and the defocused third focal plane image PFPI3. The image synthesizer 143 may generate a flicker-reduced image LFI2 corresponding to the second focal plane based on the received first focal plane image FPI1, the defocused first focal plane image PFPI1, and the defocused third focal plane image PFPI3. The image synthesizer 143 may generate one flicker-reduced image LFI2 by synthesizing, for example, the second focal plane image FPI2 corresponding to the original, and the defocused first focal plane image PFPI1 and the defocused third focal plane image PFPI3, to which the reverse lens effects are applied. The generated flicker-reduced image LFI2 may include the second object OB2, the defocused first object POB1, and the defocused third object POB3.

FIG. 7C illustrates a case where the target focal plane is the third focal plane. As in the above description, the first image processor 142_1 may receive the first focal plane image FPI1 and may generate the defocused first focal plane image PFPI1. In this case, the reverse lens effect generator 210-1 may generate the reverse lens effect with respect to the first object OB1 for the shape of the first object OB1 to be displayed on the third focal plane based on the difference between the diopter (3D) of the first focal plane and the diopter (1D) of the target focal plane, which is 2D. The defocused first focal plane image PFPI1 including the defocused first object POB1 may be generated according to the operation of the reverse lens effect generator 210-1.

The second image processor 142_2 may generate the defocused second focal plane image PFPI2. In this case, the reverse lens effect generator 210-2 may generate the reverse lens effect with respect to the second object OB2 for the shape of the second object OB2 to be displayed on the third focal plane based on the difference between the diopter (2D) of the second focal plane and the diopter (1D) of the target focal plane, which is 1D. The defocused second focal plane image PFPI2 including the defocused second object POB2 may be generated according to the operation of the reverse lens effect generator 210-2.

The image synthesizer 143 may generate one flicker-reduced image LFI3 corresponding to the third focal plane by synthesizing the third focal plane image FPI3, the defocused first focal plane image PFPI1, and the defocused second focal plane image PFPI2. The generated flicker-reduced image LFI3 may include the third object OB3, the defocused first object POB1, and the defocused second object POB2.

The flicker-reduced images LFI1 to LFI3 illustrated in FIGS. 7A to 7C may be generated according to a preset order. For example, the focal length of the focus conversion device may be changed in the order of 3D, 2D, and 1D. In this case, the flicker-reduced images LFI1 to LFI3 may be generated in the order of LFI1, LFI2, and LFI3, synchronized to each focal length. Each of the flicker-reduced images LFI1 to LFI3 may be displayed on the display panel.

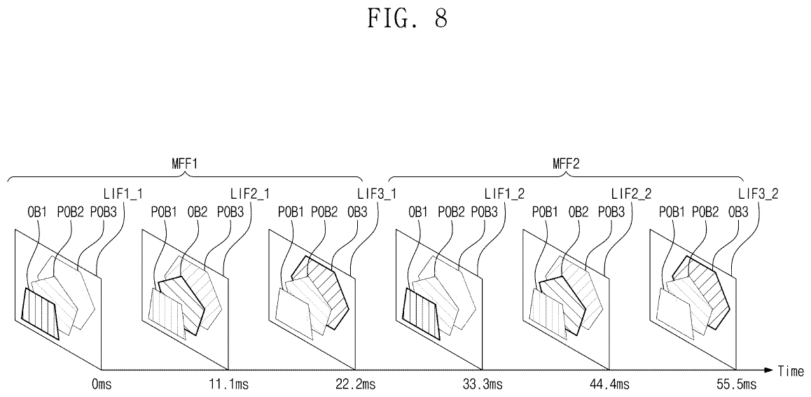

FIG. 8 is a diagram illustrating flicker-reduced images displayed on a display panel according to an embodiment of the present disclosure, according to display frames.

Referring to FIG. 8, flicker-reduced images LFI1_1, LFI2_1, and LFI3_1 may be sequentially displayed in response to a first multifocal image frame MFF1, and flicker-reduced images LFI1_2, LFI2_2, and LFI3_2 may be sequentially displayed in response to a second multifocal image frame MFF2.

The flicker-reduced image LFI1_1 and the flicker-reduced image LFI1_2 may correspond to the flicker-reduced image LFI1 illustrated in FIG. 7A. The flicker-reduced image LFI2_1 and the flicker-reduced image LFI2_2 may correspond to the flicker-reduced image LFI2 illustrated in FIG. 7B. The flicker-reduced image LFI3_1 and the flicker-reduced image LFI3_2 may correspond to the flicker-reduced image LFI3 illustrated in FIG. 7C.

At 0 ms, the focus conversion device 112 adjusts the focal length to 3D, and the display panel 111 may display the flicker-reduced image LFI1_1. The flicker-reduced image LFI1_1 may include the first object OB1, the defocused second object POB2, and the defocused third object POB3. In FIG. 5, the first focal plane image FPI1_1 displayed through the display panel 111 at 0 ms includes the first object OB1. In this case, a background color (e.g., black) may be displayed in the second object area OBA2 corresponding to the second object OB2. Additionally, the background color may be displayed in the third object area OBA3 corresponding to the third object OB3. Meanwhile, the flicker-reduced image LFI1_1 according to an embodiment of the present disclosure may display the defocused second object POB2 corresponding to the second object area OBA2 of FIG. 5. Also, the defocused third object POB3 corresponding to the third object area OBA3 of FIG. 5 may be displayed.

At 11.1 ms, the focus conversion device 112 adjusts the focal length to 2D, and the display panel 111 may display the flicker-reduced image LFI2_1. The flicker-reduced image LFI2_1 may include the second object OB2, the defocused first object POB1, and the defocused third object POB3. In FIG. 5, the second focal plane image FPI2_1 displayed through the display panel 111 at 11.1 ms includes the second object OB2. In this case, a background color may be displayed in the first object area OBA1 corresponding to the first object OB1. Additionally, the background color may be displayed in the third object area OBA3 corresponding to the third object OB3. Meanwhile, the flicker-reduced image LFI2_1 according to an embodiment of the present disclosure may display the defocused first object POB1 corresponding to the first object area OBA1 of FIG. 5. Also, the defocused third object POB3 corresponding to the third object area OBA3 of FIG. 5 may be displayed.

At 22.2 ms, the focus conversion device 112 adjusts the focal length to 1D, and the display panel 111 may display the flicker-reduced image LFI3_1. The flicker-reduced image LFI3_1 may include the third object OB3, the defocused first object POB1, and the defocused second object POB2. In FIG. 5, the third focal plane image FPI3_1 displayed through the display panel 111 at 22.2 ms includes the third object OB3. In this case, a background color may be displayed in the first object area OBA1 corresponding to the first object OB1. Additionally, the background color may be displayed in the second object area OBA2 corresponding to the second object OB2. Meanwhile, the flicker-reduced image LFI3_1 according to an embodiment of the present disclosure may display the defocused first object POB1 corresponding to the first object area OBA1 of FIG. 5. Also, the defocused second object POB2 corresponding to the second object area OBA2 of FIG. 5 may be displayed.

During the period from 0 ms before 33.3 ms when the multifocal image MFF1 is displayed, the defocused objects POB1 to POB3 may be displayed instead of the background color. For example, after the first object OB1 is displayed for a period of 0 ms to 11.1 ms, the defocused first object POB1 instead of the background color may be displayed for a period of 11.1 ms to 22.2 ms, and then the defocused first object POB1 instead of the background color may be displayed for a period of 22.2 ms to 33.3 ms.

After the defocused second object POB2 instead of the background color may be displayed for a period of 0 ms to 11.1 ms, the second object OB2 may be displayed for a period of 11.1 ms to 22.2 ms, and then the defocused second object POB2 instead of the background color may be displayed for a period of 22.2 ms to 33.3 ms.

The defocused third object POB3 instead of the background color may be displayed for a period of 0 ms to 11.1 ms, the defocused third object POB3 instead of the background color may be displayed for a period of 11.1 ms to 22.2 ms, and then the third object OB3 may be displayed for a period of 22.2 ms to 33.3 ms.

The flicker-reduced image generation device 140 according to an embodiment of the present disclosure may generate the flicker-reduced images LFI1_1 to LFI3_2 including the defocused objects POB1 to POB3. In this case, instead of displaying the objects and the background color alternately, the object and the defocused objects may be displayed alternately due to the flicker-reduced image. Through this, flickering caused by the contrast between the object and the background color may be reduced.

The multifocal display system 100 according to an embodiment of the present disclosure may display the defocused objects POB1 to POB3 instead of the background color in synchronization with the operation of the focus conversion device 112. When the images corresponding to each focal plane are displayed, the multifocal display system 100 may reduce the contrast between the images and make the frame rate of the multifocal images close to the display frame rate of the display panel. Through this, the multifocal display system 100 may display multifocal images with reduced flickering.

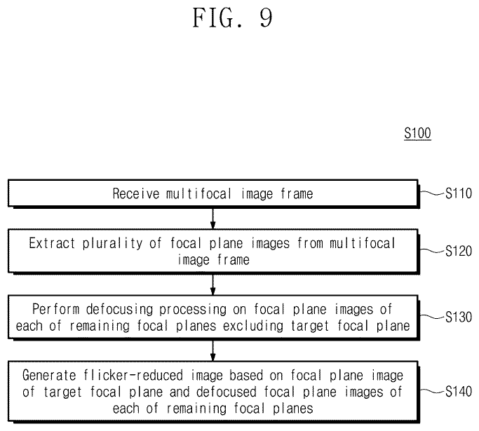

FIG. 9 is a flowchart illustrating a flicker-reduced image generation method, according to an embodiment of the present disclosure.

Referring to FIGS. 6 and 9, a flicker-reduced image generation method S100 may include operation S110 of receiving the multifocal image frame MFF and operation S120 of extracting the plurality of focal plane images FPI1 to FPI3 corresponding to each focal plane from the multifocal image frame MFF. Operations S110 and S120 may be performed by the focal plane extractor 141. The multifocal image frame MFF may include the image texture and the depth map data. The plurality of focal plane images FPI1 to FPI3 may be extracted based on the image texture and the depth map data included in the multifocal image frame.

The flicker-reduced image generation method S100 may include operation S130 of performing defocusing processing on the focal plane images FPI2 and FPI3 of each of the remaining focal planes, excluding the target focal plane. Operation S130 may be performed by the image processor 142.

The flicker-reduced image generation method S100 may include operation S140 of generating the flicker-reduced image LFI based on the focal plane image FPI1 of the target focal plane and the defocused focal plane images PFPI2 and PFPI3 of each of the remaining focal planes. Operation S140 may be performed by the image synthesizer 143.

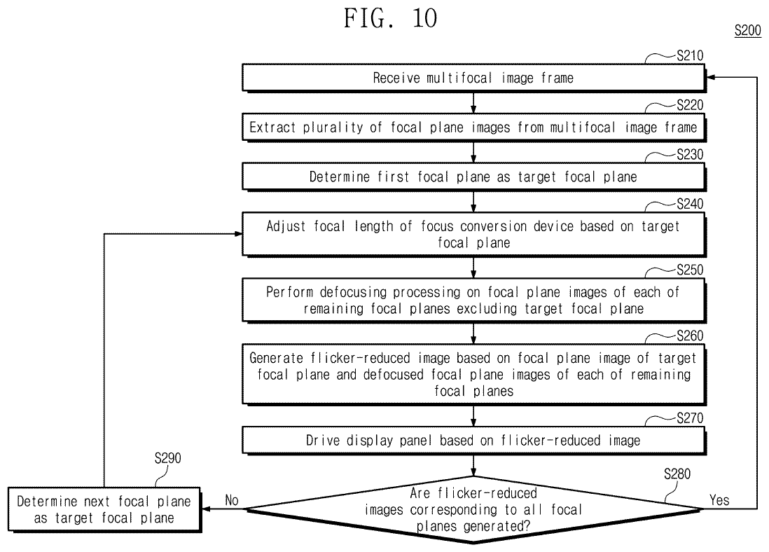

FIG. 10 is a flowchart illustrating an operating method of a multifocal display system, according to an embodiment of the present disclosure.

Referring to FIGS. 1 and 10, an operating method S200 of the multifocal display system 100 may include operation S210 of receiving the multifocal image frame MFF.

The operating method S200 of the multifocal display system 100 may include operation S220 of extracting the focal plane images FPI1 to FPI3 corresponding to each of the plurality of focal planes FP1 to FP3 from the multifocal image frame MFF. The multifocal image frame MFF may include the image texture and the depth map data. The plurality of focal plane images FPI1 to FPI3 may be extracted based on the image texture and the depth map data included in the multifocal image frame.

The operating method S200 of the multifocal display system 100 may include operation S230 of determining a first focal plane as a target focal plane.

The operating method S200 of the multifocal display system 100 may include operation S240 of adjusting the focal length of the focus conversion device 112 based on the target focal plane.

The operating method S200 of the multifocal display system 100 may include operation S250 of performing defocusing processing on focal plane images of each of the remaining focal planes excluding the target focal plane.

The operating method S200 of the multifocal display system 100 may include operation S260 of generating a flicker-reduced image based on the focal plane image of the target focal plane and the defocused focal plane images of each of the remaining focal planes.

The operating method S200 of the multifocal display system 100 may include operation S270 of driving the display panel based on the flicker-reduced image.

The operating method S200 of the multifocal display system 100 may include operation S280 of determining whether flicker-reduced images corresponding to all focal planes are generated.

The operating method S200 of the multifocal display system 100 may include operation S290 of determining the next focal plane in a preset order as the target focal plane in response to determining that flicker-reduced image is not generated for any one of all focal planes (S280—No). After operation S290, operation S240 may be performed.

The operating method S200 of the multifocal display system 100 may perform operation S210 in response to determining that flicker-reduced images corresponding to all focal planes are generated (S280—Yes).

Meanwhile, operation S240 may be performed independently (or in parallel) with operations S250, S260, and S270.

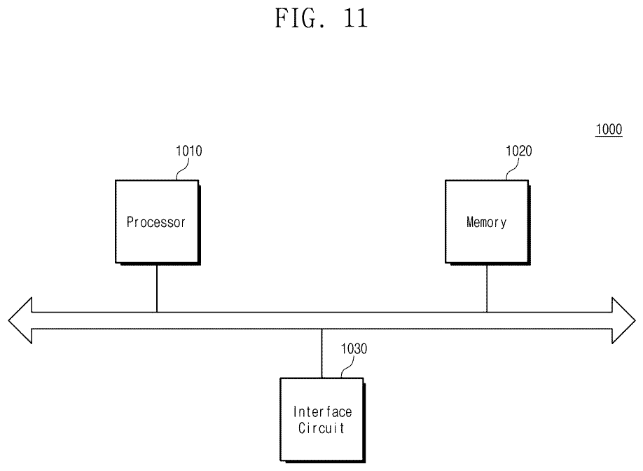

FIG. 11 is a diagram illustrating an example of a computing system implementing a flicker-reduced image generation device, according to an embodiment of the present disclosure.

Referring to FIGS. 1 and 11, a computing system 1000 may include a processor 1010, a memory 1020, and an interface circuit 1030.

The processor 1010 may control all operations, including data processing, of the flicker-reduced image generation device 140. The processor 1010 may execute firmware or software loaded onto the memory 1020. The processor 1010 may include at least one general purpose processor, such as a central processing unit (CPU), an application processor (AP), etc. Also, the processor 1010 may include at least one special-purpose processor such as a neural processing unit (NPU), a neuromorphic processor, a graphics processing unit (GPU), etc. The processor 1010 may include two or more homogeneous processors.

The memory 1020 may store codes and commands executed by the processor 1010. The memory 1020 may store data processed by the processor 1010. For example, the memory 1020 may store the multifocal image frame MFF, the plurality of extracted focal plane images FPI1 to FPI3, the defocused focal plane images PFPI2 and PFPI3, and the flicker-reduced image LFI. The memory 1020 may include a volatile memory such as a RAM (Random Access Memory) or a SRAM (Static Random Access Memory), or a nonvolatile memory including at least one of a flash memory type memory, a hard disk type memory, a multimedia card micro type memory, a card type memory (e.g., an SD memory or an XD memory, etc.), a ROM (Read-Only Memory), an EEPROM (Electrically Erasable Programmable Read-Only Memory), and a PROM (Programmable Read-Only Memory).

The interface circuit 1030 may provide signal or data communication between the computing system 1000 and the outside. For example, the processor 1010 may receive the multifocal image frame MFF from the outside (e.g., a host) through the interface circuit 1030. The processor 1010 may generate the flicker-reduced image LFI displayed through the display device 110. The interface circuit 1030 may output the flicker-reduced image LFI.

Meanwhile, the flicker-reduced image generation device 140 and the controller 130 may be implemented with the same configuration. For example, the flicker-reduced image generation device 140 and the controller 130 may be implemented as the computing system 1000. The computing system 1000 may receive the multifocal image frame MFF, may generate the flicker-reduced image LFI, and may generate the image data DATA and the control signal CS based on the generated flicker-reduced image LFI.

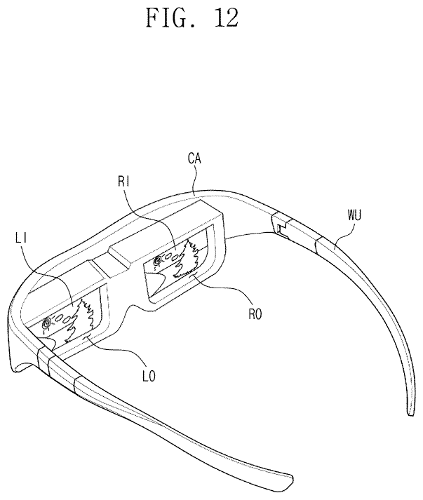

FIG. 12 is a diagram illustrating a head-mounted display device, according to an embodiment of the present disclosure.

Referring to FIGS. 1 and 12, a head-mounted display device may be mounted on a user's head and may display a left-eye image LI and a right-eye image RI on each of the user's eyes. The head-mounted display device may include a case CA and a wearable unit WU connected to the case CA.

The case CA may be worn on at least a portion (e.g., the facial side) of the user's face and may be supported on the user's face by various components. The case CA may accommodate and support a left-eye display panel, a right-eye display panel, a left-eye focus conversion device, and a right-eye focus conversion device. The case CA may be formed in any shape as long as it may be mounted on the user's head while supporting the left-eye display panel, the right-eye display panel, the left-eye focus conversion device, and the right-eye focus conversion device. The case CA may take various shapes, including, for example, a glasses shape or a helmet shape. The left-eye display panel and the right-eye display panel accommodated in the case CA may correspond to the pair of display panels 111 included in the display device 110 of FIG. 1. The left-eye display panel may correspond to the display panel 111 for the left-eye of FIG. 1, and the right-eye display panel may correspond to the display panel 111 for the right-eye of FIG. 1. The left-eye focus conversion device and the right-eye focus conversion device accommodated in the case CA may correspond to the pair of focus conversion devices 112 included in the display device 110 of FIG. 1. The left-eye focus conversion device may correspond to the focus conversion device 112 for the left-eye of FIG. 1, and the right-eye focus conversion device may correspond to the focus conversion device 112 for the right-eye of FIG. 1.

In the case CA, a left-eye aperture LO and a right-eye aperture RO, through which the left-eye image LI and the right-eye image RI are displayed, are disposed, respectively, in a housing accommodating the left-eye display panel, the right-eye display panel, the left-eye focus conversion device, and the right-eye focus conversion device. The left-eye image LI displayed on the left-eye display panel may be viewed by the user's left eye through the left-eye aperture LO via the left-eye focus conversion device, and the right-eye image RI displayed on the right-eye display panel may be viewed by the user's right eye through the right-eye aperture RO via the right-eye focus conversion device. Meanwhile, in an embodiment, another aperture (not illustrated) may be included in addition to the left-eye aperture LO and the right-eye aperture RO. When the left-eye display panel and the right-eye display panel are transparent displays, this additional aperture allows the user to simultaneously view the surrounding background in addition to the displayed image. This may be utilized to utilize augmented reality (AR) technology or virtual reality (VR) technology.

The wearable unit WU secures the case CA to the user's head. The wearable unit WU may be formed of any shape or material, as long as it may secure the case CA to the user's head. For example, when the head-mounted display device has a glasses-like shape, the wearable unit WU may have a temple-like shape, as illustrated in FIG. 12. In an embodiment, the wearable unit WU may also have a band-like shape that surrounds the user's head.

According to an embodiment of the present disclosure, the flicker-reduced image generation device, the multifocal display system, and the operating method thereof may generate images with a reduced flicker effect by performing defocusing processing on focal plane images of different focal planes and displaying the images by synthesizing them with the focal plane image of the target focal plane.

The above description refers to embodiments for implementing the present disclosure. Embodiments in which a design is simply changed or which are easily changed may be included in the present disclosure as well as an embodiment described above. In addition, technologies that are easily changed and implemented by using the above embodiments may be included in the present disclosure. Therefore, the scope of the present disclosure should not be limited to the above-described embodiments and should be defined by not only the claims to be described later, but also those equivalent to the claims of the present disclosure.

What is claimed is:

1. A flicker-reduced image generation device comprising:
a focal plane extractor configured to receive a multifocal image frame and to extract a plurality of focal plane images corresponding to each of a plurality of focal planes from the multifocal image frame;
at least one image processor configured to perform defocusing processing on focal plane images of each of remaining focal planes excluding a target focal plane among the plurality of focal planes;
an image synthesizer configured to generate a flicker-reduced image corresponding to the target focal plane based on a focal plane image of the target focal plane and the defocused focal plane images of each of the remaining focal planes; and
an operation controller configured to determine the target focal plane among the plurality of focal planes and to control the focal plane extractor, the at least one image processor, and the image synthesizer to generate the flicker-reduced image.

2. The flicker-reduced image generation device of claim 1, wherein the operation controller sequentially determines the focal plane image of the target focal plane according to a preset order with respect to the plurality of focal plane images.

3. The flicker-reduced image generation device of claim 1, wherein the operation controller controls the focal plane extractor to receive a new multifocal image frame in response to the generation of flicker-reduced images corresponding to each of the plurality of focal planes.

4. The flicker-reduced image generation device of claim 1, wherein the defocusing process includes a blur filtering.

5. The flicker-reduced image generation device of claim 1, wherein the at least one image processor includes a first image processor configured to perform defocusing processing on a focal plane image of a first focal plane among the remaining focal planes; and
a second image processor configured to perform defocusing processing on a focal plane image of a second focal plane among the remaining focal planes, and
wherein the first image processor and the second image processor operate in parallel.

6. The flicker-reduced image generation device of claim 5, wherein the first image processor includes a reverse lens effect generator configured to generate a reverse lens effect based on a diopter difference between the first focal plane and the target focal plane.

7. The flicker-reduced image generation device of claim 6, wherein the reverse lens effect generator generates the reverse lens effect based on a geometrical optical method.

8. The flicker-reduced image generation device of claim 5, wherein the first image processor includes a light field calculator configured to perform a light field calculation based on light rays directed from each of the remaining focal planes to the target focal plane.

9. A multifocal display system comprising:
a display device including at least one display panel and at least one focus conversion device;
a driving circuit configured to generate a display driving signal for driving the display panel and a driving synchronization signal for controlling an operation of the focus conversion device synchronized with the display panel;
a controller configured to output image data displayed on the display panel and a control signal for controlling the driving circuit; and
a flicker-reduced image generation device configured to receive a multifocal image frame, to extract a plurality of focal plane images corresponding to each of a plurality of focal planes from the multifocal image frame, to determine a target focal plane among the plurality of focal planes, to perform defocusing processing on focal plane images of each of remaining focal planes excluding the target focal plane among the plurality of focal planes, to generate a flicker-reduced image corresponding to the target focal plane based on a focal plane image of the target focal plane and the defocused focal plane images of each of the remaining focal planes, and to output the flicker-reduced image to the controller.

10. The multifocal display system of claim 9, wherein the flicker-reduced image generation device sequentially determines the target focal plane according to a preset order.

11. The multifocal display system of claim 9, wherein the at least one display panel includes a first display panel for a left eye and a second display panel for a right eye, and
the at least one focus conversion device includes a first focus conversion device corresponding to the first display panel and a second focus conversion device corresponding to the second display panel.

12. The multifocal display system of claim 11, wherein the flicker-reduced image generation device generates a first flicker-reduced image corresponding to the first display panel and a second flicker-reduced image corresponding to the second display panel.

13. The multifocal display system of claim 11, wherein each of the first focus conversion device and the second focus conversion device adjusts a focal length corresponding to a same focal plane.

14. The multifocal display system of claim 9, wherein the flicker-reduced image generation device performs the defocusing processing in parallel with respect to each of a focal plane image of a first focal plane and a focal plane image of a second focal plane among the remaining focal planes.

15. The multifocal display system of claim 14, wherein the flicker-reduced image generation device generates a reverse lens effect based on a diopter difference between the first focal plane and the target focal plane.

16. The multifocal display system of claim 15, wherein the flicker-reduced image generation device generates the reverse lens effect based on a geometric optical method.

17. The multifocal display system of claim 9, wherein the flicker-reduced image generation device performs a light field calculation based on a direction of light rays directed toward each of a plurality of focal planes.

18. A method of operating a multifocal display system, the method comprising:
receiving a multifocal image frame;
extracting a plurality of focal plane images corresponding to each of a plurality of focal planes from the multifocal image frame;
determining a target focal plane among the plurality of focal planes;
performing defocusing processing on focal plane images of each of remaining focal planes excluding the target focal plane among the plurality of focal planes; and
generating a flicker-reduced image corresponding to the target focal plane based on a focal plane image of the target focal plane and the defocused focal plane images of each of the remaining focal planes.

19. The method of claim 18, further comprising:
adjusting a focal length of the focus conversion device based on the target focal plane.

20. The method of claim 18, further comprising:
determining whether the flicker-reduced image is generated with respect to all of the plurality of focal planes; and
determining a next focal plane in a preset order as the target focal plane in response to determining that a flicker-reduced image is not generated with respect to any one of the plurality of focal planes.
